(19) United States
(12) Patent Application Publication
(10) Pub. No.: US 2025/0286122 A1
(43) Pub. Date: Sep. 11, 2025

(54) METHODS FOR THE PRODUCTION OF SULPHIDE BASED LITHIUM-ION CONDUCTING SOLID ELECTROLYTE

(71) Applicant: Umicore, Brussels (BE)

(72) Inventors: Antoine BREHAULT, Acigné (FR); Pol BRIANTAIS, Acigné (FR); Yann GUIMOND, Acigné (FR); Tom KREKELS, Olen (BE)

(21) Appl. No.: 18/861,942

(22) PCT Filed: May 3, 2023
(86) PCT No.: PCT/EP2023/061633

§ 371 Date: Oct. 31, 2024

(30) Foreign Application Priority Data
May 4, 2022 (EP) 22290025.0
May 4, 2022 (EP) 22290026.8
May 4, 2022 (EP) 22290027.6

(51) Int. Cl. H01M 10/0562; C03C 3/14; C03C 4/14

(52) U.S. Cl. CPC H01M 10/0562; C03C 3/14; C03C 4/14; C03C 2204/00; H01M 2300/008

(57) ABSTRACT

The present invention relates to methods for the production of solid materials which are obtainable by melt-quenching mixtures comprising lithium sulphide and boron sulphide, thereby forming a glassy solid which is suitable for use as a lithium-ion conducting electrolyte. The present inventors have demonstrated that the method results in the production of sulphide based lithium-ion conducting solid electrolytes of improved quality, in particular having less inclusions of foreign material, such as gas bubbles.

### TECHNICAL FIELD AND BACKGROUND

The present invention relates to methods for the production of solid materials which are obtainable by melt-quenching mixtures comprising lithium sulphide and boron oxide, thereby forming a glassy solid which is suitable for use as a lithium-ion conducting electrolyte.

The three primary functional components of a lithium-ion battery are the anode, the cathode, and the electrolyte. While many variations exist, the anode of a conventional lithium-ion cell is typically made from carbon, the cathode is typically made from transition metal oxides (in particular oxides of cobalt, nickel and/or manganese), and the electrolyte is typically a non-aqueous solvent containing a lithium salt. For example, mixtures of organic carbonates with lithium hexafluorophosphate are well known liquid electrolytes for lithium-ion batteries.

A significant disadvantage of liquid electrolytes is that the compositions, in particular the solvents are inflammable, which poses a large safety risk during normal operation and in particular in case of an incident. Another disadvantage is inherent to the liquid nature of the electrolyte, associated with risks of leakage and with increased risk of environmental pollution in case of a spill or leakage.

Recently, efforts have been made to develop solid electrolytes which allow the provision of a solid-state lithium-ion battery. Such solid-state batteries have significantly reduced EHS (environmental, health and safety) hazards. An emerging class of lithium-ion conducting solid electrolytes are sulphide based amorphous solids (interchangeably referred to as glassy solids) such as Li₂S—SiS₂, Li₂S—P₂S₅ or Li₂S—B₂S₃. In glassy solid electrolyte materials, the absence of crystalline pathways leads to isotropic conduction substantially without any grain boundary resistance. The absence of grain boundaries in glassy electrolyte materials may also prevent dendrite formation because glassy amorphous electrolyte materials may be obtained as dense, defect free films by a melt-quench approach.

Early studies on Li₂S—B₂S₃ compositions having a molar ratio of 70:30 and 60:40 reported ΔTₓ values of about 70° C. and about 110° C., respectively (Zhang et al, Solid State Ionics 1990, 38, 217-224).

US5500291 contemplates sulphide based lithium-ion conducting solid electrolytes of the type Li₂S—SiS₂—Li₄SiO₄.

WO2020/254314 A1 contemplates sulphide based lithium-ion conducting solid electrolytes of the type Li₂S—B₂S₃ obtained from mixtures further comprising P, Si, Ge, As or Sb oxides in combination with lithium halides.

WO2016/089899 A1 contemplates a plethora of glass systems (many of which are speculative or unsupported).

A major challenge in the production of glassy solid electrolytes is the avoidance of impurities or inclusions in the glass. Ideally the glass is a continuous homogenous amorphous bulk. However, in practice the glass is typically characterized by irregular inclusions of deviating material. This deviating material could be anything such as unwanted zones of crystallized material, unreacted precursors, impurities originating from the precursors, gas bubbles, etc. Inclusions presence is a problem for the post processing of the glass. This type of defect can act as nucleation agent and will favor crystallization of the material. The presence of defects induce a material that is no longer isotropic so it is problematic for protective behavior against dendrite.

Presently, there is therefore a significant need to provide methods to produce sulphide based lithium-ion conducting solid electrolytes of increased quality, having less inclusions of deviating material, such as unwanted zones of crystallized material, unreacted precursors, impurities originating from the precursors, gas bubbles, etc.

It is an object of the present invention to provide methods for the production of sulphide based lithium-ion conducting solid electrolytes of improved quality, in particular having less inclusions of foreign material, such as gas bubbles.

It is another object of the present invention to provide methods for the production of sulphide based lithium-ion conducting solid electrolytes having improved reproducibility compared to prior art methods.

### SUMMARY OF THE INVENTION

The present inventors have found that one or more objects of the invention can be achieved by methods for the production of sulphide based lithium-ion conducting solid electrolytes comprising melt-quenching a combination of Li₂S; Boron; Sulfur; B₂O₃ and optionally LiX, wherein X represents F, Cl, Br, I, N₃, SCN, CN, OCN, BF₄, BH₄ or combinations thereof, preferably X represents CI, Br, I or combinations thereof. As is shown in the appended examples, it is indeed observed that the resulting glassy solids exhibit less inclusions of deviating material, in particular less inclusions of gas bubbles, compared to material prepared using B₂S₃ instead of both boron and sulfur.

### Embodiment 1

Accordingly, in a first aspect of the present invention, there is provided a method for preparing a solid material comprising the steps of:
(i) providing the following precursors:
   Li₂S;
   both of boron and sulfur;
   B₂O₃; and
   optionally LiX wherein X represents F, Cl, Br, I, N₃, SCN, CN, OCN, BF₄, BH₄ or combinations thereof, preferably X represents Cl, Br, I or combinations thereof;
(ii) preparing a mixture comprising the precursors provided in step (i);
(iii) heat-treating the mixture prepared in step (ii) to obtain a melt; and
(iv) quenching the melt obtained in step (iii) to obtain the solid material.

### Embodiment 2

In another aspect of the present invention, there is provided a solid material which is obtainable by the method described herein (i.e. the method of embodiment 1).

### Embodiment 3

In another aspect of the invention, there is provided a solid composition comprising a first solid material which is the solid material as described herein (i.e. the solid material of embodiment 2), and further comprising at least a second solid material having a different composition than the first solid material.

### Embodiment 4

In another aspect of the invention, there is provided an electrochemical cell comprising the solid material as described herein (i.e. the solid material of embodiment 2).

### Embodiment 5

In another aspect of the invention, there is provided the use of the solid material as described herein (i.e. the solid material of embodiment 2), or of the solid composition as described herein (i.e. the solid composition of embodiment 3), as a solid electrolyte for an electrochemical cell.

### Embodiment 6

Another aspect of the present invention concerns batteries, more specifically a lithium ion battery or a lithium metal battery comprising at least one electrochemical cell comprising the solid material as described herein (i.e. the solid material of embodiment 2), for example two or more electrochemical cells as described in embodiment 4.

### Embodiment 7

A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one battery or at least one electrochemical cell comprising the solid material as described herein (i.e. the electrochemical cell as described in embodiment 4).

### Embodiment 8

A further aspect of the present disclosure is the use of the electrochemical cell comprising the solid material of the invention (i.e. the electrochemical cell as described in embodiment 4) in motor vehicles, bicycles operated by electric motor, robots, aircraft (for example unmanned aerial vehicles including drones), ships or stationary energy stores.

### DETAILED DESCRIPTION OF THE INVENTION

In the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

The thermal stability of a glass ΔTₓ can be characterized as the stability against crystallization, which is determined by the temperature difference between the onset of crystallization (Tₓ) and the onset of the glass transition temperature (T_{g}), i.e. ΔTₓ=Tₓ−T_{g}. A larger ΔTₓ is generally associated with improved glass-forming ability and increased glass stability during post-processing.

The glass transition temperature (T_{g}), as referred to herein, refers to the temperature of the onset of glass transition as determined by Differential Scanning calorimetry (DSC). It is preferably determined by constructing tangents to the DSC curve baselines before and after the glass transition and determining the extrapolated onset temperature by intersection of these tangents, essentially corresponding to the temperature where the highest slope in the drop of the DSC baseline occurs before the exothermic crystallization peak The DSC is preferably recorded using the following temperature profile: from 100° C. to 350° C. at a rate of 10° C./min, and preferably it is recorded on a 5-10 mg sample in a sealed aluminium pan. A suitable DSC apparatus is a DSC 3500 Sirius.

The thermal stability (ΔTₓ) as referred to herein is the difference between the crystallization onset temperature as determined by DSC (Tₓ) and the glass transition temperature as determined by DSC (T_{g}). In other words: ΔTₓ=Tₓ−T_{g}.

The ionic conductivity as referred to herein, refers to the ionic conductivity determined by electrochemical impedance spectroscopy (EIS) at 25° C. It is preferably determined with ion-blocking electrodes on hot pressed samples which were densified at 350 MPa at 125° C. for 5 min after which the ionic conductivity was measured at 25° C. under an operational pressure of 125 MPa. Preferably an excitation voltage of 10 mV was applied in the frequency range of 7 MHZ-1 Hz and the data was interpreted by means of an equivalent circuit analysis. A suitable conductivity analyzer is a potentiostat with frequency analyzer such as is available from Biologic.

The electronic conductivity as referred to herein, refers to the electronic conductivity determined at 25° C. It is preferably determined with ion-blocking electrodes on hot pressed samples which were densified at 350 MPa at 125° C. for 5 min after which the electronic conductivity was measured at 25° C. under an operational pressure of 125 MPa. Preferably the electronic conductivity was measured via stepwise potentiostatic polarization at 0.2, 0.4 and 0.6 V for 20 min. A suitable conductivity analyzer is a potentiostat with frequency analyzer such as is available from Biologic.

### Embodiment 1

In a first aspect of the invention there is provided a method for preparing a solid material comprising the steps of:
(i) providing the following precursors:
   Li₂S;
   both of boron and sulfur;
   B₂O₃; and
   optionally LiX wherein X represents F, Cl, Br, I, N₃, SCN, CN, OCN, BF₄, BH₄ or combinations thereof;
(ii) preparing a mixture comprising the precursors provided in step (i);
(iii) heat-treating the mixture prepared in step (ii) to obtain a melt; and
(iv) quenching the melt obtained in step (iii) to obtain the solid material.

In preferred embodiments of the invention, no other precursors are employed in the method. Hence, the solid material obtained in step (iv) is preferably the melt-quench product of solely Li₂S; Boron; Sulfur; B₂O₃ and optionally LiX, wherein X represents F, Cl, Br, I, N₃, SCN, CN, OCN, BF₄, BH₄ or combinations thereof.

In preferred embodiments of the invention, a method for preparing a solid material comprising the steps of:
(i) providing the following precursors:
   Li₂S;
   both of boron and sulfur;
   B₂O₃; and
   optionally LiX wherein X represents CI, Br, I or combinations thereof;
(ii) preparing a mixture comprising the precursors provided in step (i);
(iii) heat-treating the mixture prepared in step (ii) to obtain a melt; and
(iv) quenching the melt obtained in step (iii) to obtain the solid material.

In preferred embodiments of the invention, no other precursors are employed in the method. Hence, the solid material obtained in step (iv) is preferably the melt-quench product of solely Li₂S; Boron; Sulfur; B₂O₃ and optionally LiX, wherein X represents CI, Br, I or combinations thereof.

It is preferred that the molar ratio of the precursors in the mixture before quenching is such that in step (ii) a composition according to general formula (I) is obtained

((Li₂S)ₓ(B₂S₃)_{y}(B₂O₃)_{z})_{A}(LiX)_{B} (I)
wherein
x is within the range of 55 to 85, preferably 55 to 75, more preferably 60 to 70;
y is within the range of 15 to 45, preferably 20 to 40, more preferably 25 to 35;
z is within the range of 0 to 15, preferably 0 to 10, more preferably 0 to 6;
x+y+z=100; and
the ratio A:B is within the range of 60:40 to 100:0.

As will be understood by the skilled person in view of the definition of A and B in formula (I), the ratio A:B concerns the molar ratio of a fictional product obtainable by mixing precursors Li₂S; Boron; Sulfur; B₂O₃ in molar ratios x, y and z to precursor LiX. In practice it is most convenient if all precursors are simply mixed compliant to the ratios prescribed by general formula (I) and then submitted to melt-quenching.

The provision of both of boron and sulfur in step (i) should be interpreted to mean the provision of elemental boron and elemental sulfur. The elemental boron and elemental sulfur may be provided in amorphous or crystalline form, wherein the specific allotrope used is not particularly limiting for the invention. Preferably, the methods of the present invention are provided wherein the mixture comprising the precursors provided in step (i) does not comprise boron sulfide (B₂S₃).

In preferred embodiments of the invention, the method is provided wherein
x is within the range of 55 to 85, preferably 55 to 75, more preferably 60 to 70;
y is within the range of 15 to 45, preferably 20 to 40, more preferably 25 to 35;
z is within the range of 1 to 15, preferably 1 to 10, more preferably 1 to 6; and
x+y+z=100.

In preferred embodiments of the invention, the method is provided wherein
x is within the range of 62 to 68, preferably within the range of 63 to 67, more preferably within the range of 64 to 66;
y is within the range of 27 to 33, preferably within the range of 28 to 32, more preferably within the range of 29 to 31;
z is within the range of 1 to 8, preferably within the range of 3 to 7, more preferably within the range of 4 to 6; and
X+y+z=100.

In accordance with highly preferred embodiments of the invention, the method is provided wherein
x is about 65;
y is about 30; and
z is about 5.

In general, it is preferred that the ratio A:B in the mixture before quenching is within the range of 75:25 to 98:2, preferably 80:20 to 96:4, more preferably 85:15 to 96:4. In some embodiments the ratio A:B in the mixture before quenching is within the range of 60:40 to 96:4, preferably within the range of 70:30 to 96:4, more preferably within the range of 75:25 to 96:4. In some embodiments the ratio A:B in the mixture before quenching is within the range of 60:40 to 94:6, preferably within the range of 70:30 to 93:7, more preferably within the range of 75:25 to 92:8.

Hence, in some embodiments of the invention the method is provided wherein
x is within the range of 62 to 68, preferably within the range of 63 to 67, more preferably within the range of 64 to 66;
y is within the range of 27 to 33, preferably within the range of 28 to 32, more preferably within the range of 29 to 31;
z is within the range of 1 to 8, preferably within the range of 3 to 7, more preferably within the range of 4 to 6;
x+y+z=100; and
the ratio A:B in the mixture before quenching is within the range of 85:25 to 98:2, preferably within the range of 80:20 to 96:4, more preferably within the range of 85:15 to 96:4.

In some embodiments of the invention the method is provided wherein
x is about 65;
y is about 30;
z is about 5;
x+y+z=100; and
the ratio A:B in the mixture before quenching is within the range of 85:25 to 98:2, preferably within the range of 80:20 to 96:4, more preferably within the range of 85:15 to 96:4.

In accordance with preferred embodiments of the invention, the method is provided wherein X represents Br, I or a combination thereof. As is shown in the appended examples, these materials outperform the materials wherein X represent CI with regard to thermal stability ΔTₓ.

In accordance with preferred embodiments of the invention, the method is provided wherein at least 50 mol % of X represents Br, preferably at least 80 mol % of X represents Br, most preferably X represents Br. As is shown in the appended examples, the materials wherein X represents Br outperform the materials wherein X represent CI with regard to thermal stability ΔTₓ.

In accordance with preferred embodiments of the invention, the method is provided wherein X represents Br, I or a combination thereof and wherein at least 50 mol % of X represents Br, preferably at least 80 mol % of X represents Br.

The solid materials obtained in step (iv) of the method of the present invention are typically glassy solids. In some embodiments, the solid material obtained in step (iv) is in the form of a monolithic glass, such as a melt-case monolithic glass. It is preferred that the glassy solid is essentially free of crystalline phases. This may mean that in some embodiments the amount of crystalline phases as determined by X-ray diffraction is less than 5 vol % of the solid material, preferably less than 2 vol %, more preferably less than 1 vol %. A phase is considered crystalline if the intensity of its reflection is more than 10% above the background.

It was found that the solid materials obtained in step (iv) of the method of the present invention have a surprisingly high ionic conductivity. In accordance with preferred embodiments of the invention, the method is provided wherein the material obtained in step (iv) has an ionic conductivity at 25° C. of at least 0.1 mS/cm, preferably at least 0.3 mS/cm. As is shown in the appended examples the present inventors have surprisingly found that in case at least 50 mol % of X represents Br, preferably at least 80 mol % of X represents Br, most preferably X represents Br, the ionic conductivity at 25° C. can be as high as 2 mS/cm. Hence, in some embodiments of the invention, the method is provided wherein the material obtained in step (iv) has an ionic conductivity at 25° C. of at least 1 mS/cm, preferably at least 1.1 mS/cm, more preferably at least 1.2 mS/cm. In particular embodiments of the invention:
at least 50 mol % of X represents Br, preferably at least 80 mol % of X represents Br, most preferably X represents Br; and
the solid material obtained in step (iv) has an ionic conductivity at 25° C. of at least 1 mS/cm, preferably at least 1.1 mS/cm, more preferably at least 1.2 mS/cm.

For example in some embodiments of the method of the invention at least 80 mol % of X represents Br and the ionic conductivity of the solid material obtained in step (iv) at 25° C. is at least 1.1 mS/cm, or X represents Br and the ionic conductivity of the solid material obtained in step (iv) at 25° C. is at least 1.2 mS/cm, such as at least 1.21 mS/cm or at least 1.25 mS/cm.

It was found that the solid materials obtained in step (iv) combine said high ionic conductivity with surprisingly low electronic conductivity, which makes them extremely attractive solid state battery electrolyte materials. In accordance with preferred embodiments of the invention, the method is provided wherein the material obtained in step (iv) has an electronic conductivity at 25° C. of less than 1×10⁻⁴ mS/cm, preferably less than 6×10⁻⁵ mS/cm. As is shown in the appended examples the present inventors have surprisingly found that in case X represents Br, I or a combination thereof, the electronic conductivity at 25° C. can be very low, such as less than 1×10⁻⁹ mS/cm or less than 1×10⁻¹⁰ mS/cm. Hence, in some embodiments of the invention, the method is provided wherein the material obtained in step (iv) has an electronic conductivity at 25° C. of less than 1×10⁻⁵ mS/cm, preferably less than 1×10⁻⁶ mS/cm. In particular embodiments of the invention:
X represents Br, I or a combination thereof; and
the solid material obtained in step (iv) has an electronic conductivity at 25° C. of less than 1×10⁻⁹ mS/cm or less than 1×10⁻¹⁰ mS/cm.

In some particularly preferred embodiments of the invention, the method is provided wherein the material obtained in step (iv) combines a high ionic conductivity with a low electronic conductivity. As is shown in the appended examples, this is possible when X represents Br. For example, in some embodiments of the method of the invention:
at least 50 mol % of X represents Br, preferably at least 80 mol % of X represents Br, most preferably X represents Br;
the solid material obtained in step (iv) has an ionic conductivity at 25° C. of at least 1 mS/cm, preferably at least 1.1 mS/cm, more preferably at least 1.2 mS/cm; and
the solid material obtained in step (iv) has an electronic conductivity at 25° C. of less than 1×10⁻⁹ mS/cm or less than 1×10⁻¹⁰ mS/cm.

For example, in some embodiments at least 50 mol % of X represents Br, preferably at least 80 mol % of X represents Br, most preferably X represents Br; the solid material obtained in step (iv) has an ionic conductivity at 25° C. of at least 2 mS/cm and the solid material obtained in step (iv) has an electronic conductivity at 25° C. of less than 1×10⁻⁹ mS/cm or less than 1×10⁻¹⁰ mS/cm.

As is shown in the appended examples, it was found that the methods of the present invention yield glassy solids exhibiting a high thermal stability ΔTₓ for Li—S based glasses. In accordance with preferred embodiments of the invention, the method is provided wherein the material obtained in step (iv) has a thermal stability ΔTₓ of more than 100° C., preferably more than 110° C., more preferably more than 115° C. In some embodiments, particularly when X represents Br, I or a combination thereof, the thermal stability ΔTₓ is more than 120° C., preferably more than 125° C., more preferably more than 130° C.

In certain highly preferred embodiments, the method of the invention is provided wherein
the solid material obtained in step (iv) has an ionic conductivity at 25° C. of at least 0.1 mS/cm, preferably at least 0.3 mS/cm;
the solid material obtained in step (iv) has a thermal stability ΔTₓ of more than 100° C., preferably more than 110° C., more preferably more than 115° C.; and
preferably the solid material obtained in step (iv) has an electronic conductivity at 25° C. of less than 1×10⁻⁵ mS/cm, preferably less than 1×10⁻⁶ mS/cm.

In certain highly preferred embodiments, the method is provided wherein
at least 50 mol % of X represents Br, preferably at least 80 mol % of X represents Br, most preferably X represents Br;
the solid material obtained in step (iv) has an ionic conductivity at 25° C. of at least 1 mS/cm, preferably at least 1.1 mS/cm, more preferably at least 1.2 mS/cm;
the solid material obtained in step (iv) has a thermal stability ΔTₓ of more than 120° C., preferably more than 125° C., more preferably more than 130° C.; and
preferably the solid material obtained in step (iv) has an electronic conductivity at 25° C. of less than 1×10⁻⁹ mS/cm or less than 1×10⁻¹⁰ mS/cm.

For example, in some embodiments X represents I or Br, preferably Br; the solid material obtained in step (iv) has an ionic conductivity at 25° C. of at least 1.5 mS/cm, more preferably at least 2 mS/cm; and the solid material obtained in step (iv) has a thermal stability ΔTₓ of more than 115° C., preferably more than 125° C.

For some applications it may be preferable that the material obtained in step (iv) is provided in the form of a particulate solid, such as a powder. This may facilitate blending with e.g. cathode material. The solid obtained in step (iv) may be obtained directly in the form of a particulate solid (such as a powder) or may be comminuted (such as by milling, grinding, etc.) to a particulate solid (such as a powder). For other applications it may be preferable that the solid material obtained in step (iv) is provided in the form of a thin sheet or film, preferably a sheet or film having a thickness of less than 500 micron, preferably less than 100 micron.

Preparing the mixture of step (ii) may be performed by any suitable means, preferably by mechanical milling (e.g. ball milling).

Step (iii) involves heating the mixture prepared in step (ii) to obtain a melt, i.e. heat-treating at a temperature above the melting temperature of the mixture prepared in step (ii). Step (iii) preferably comprises heat-treating the mixture prepared in step (ii) at a temperature of at least 400° C., preferably at least 600° C., more preferably at least 800° C. The mixture is preferably kept at this temperature for at least 15 minutes, preferably at least 30 minutes, more preferably at least 2 hours.

Heat-treating may be performed in a closed vessel. The closed vessel may be a sealed quartz tube or any other type of container which his capable of withstanding the temperature of the thermal treatment and is not subject to reaction with the constituents of the glass, such a closed vessel made from a material selected from magnesium oxide, boron nitride, copper, tungsten, silicon nitride, aluminum nitride, carbon and combinations thereof. The heat-treatment of step (iii) may be a single stage or a multiple stage heat-treatment.

It is preferred that step (iii) is performed under an inert gas atmosphere, preferably an inert atmosphere comprising one or more noble gases (such as argon) and/or at a pressure of less than 1 atm, preferably of less than 0.1 atm, more preferably of less than 0.01 atm. Typically and thus preferably, step (iii) is performed at a pressure of less than 10-4 atm, preferably less than 10-5 atm and preferably under an inert gas atmosphere, preferably an inert atmosphere comprising one or more noble gases (such as argon). The use of nitrogen as inert atmosphere is generally to be avoided in view of potential reaction with the glass precursors.

In some embodiments of the method of the invention step (iv) further comprises the steps of:
(iv) a quenching the melt obtained in step (iii) to obtain solid material;
(iv) b comminuting the solid material of step (iv) a to obtain a particulate solid, such as a powder; and
(iv) c optionally forming a thin film or sheet, preferably a film or sheet having a thickness of less than 500 micron, preferably less than 100 micron by:
   dissolving or suspending the particulate solid of step (iv) b in a liquid phase to obtain a solution or suspension, followed by deposition from the solution or suspension to obtain the thin film or sheet; or
   reheating the particulate solid of step (iv) b to a temperature sufficient to allow drawing a film or sheet, and drawing said film or sheet.

In alternative embodiments step (iv) comprises quenching the melt of step (iii) while maintaining the temperature sufficiently high to allow drawing a thin film or sheet, and drawing said film or sheet, preferably drawing a film or sheet having a thickness of less than 500 micron, preferably less than 100 micron.

It is preferred that the method is operated in the form of a continuous process to produce a continuous glass film or sheet which is cut to a desired size.

The step of quenching in step (iv) is preferably performed by contacting the melt obtained in step (iii) directly, or by contacting the vessel while closed or opened (preferably while closed), with water, ice, an optionally cooled gas (such as air), an optionally cooled metal plate (such as via roller quenching), and/or a chemically inert mold.

The solid material obtained in step (iv) is preferably substantially free of gas inclusions, in particular substantially free of gas inclusions at the edge of the material.

The present inventors contemplate that the addition of small amounts of other materials during synthesis in such a way that the general formula (I) of the resulting solid material is no longer respected; but wherein the changes do not materially affect the basic and novel characteristic(s) of the solid materials of the invention is possible. Such modifications are considered within the scope of the general formula (I) for the purposes of the present invention.

### Embodiment 2

In another aspect of the present invention, there is provided a solid material which is obtainable by the method described herein (i.e. the method of embodiment 1). Such solid materials are characterized in that they are substantially free of gas inclusions, in particular substantially free of gas inclusions at the edge of the material. As is shown in the appended examples, the method of the invention allows a material free of edge bubbles to be obtained.

### Embodiment 3

In another aspect of the invention, there is provided a solid composition comprising a first solid material which is the solid material as described herein (i.e. the solid material of embodiment 2), and further comprising at least a second solid material having a different composition than the first solid material. The first solid material may be present in the form of discrete particles embedded in a matrix of the second solid material. Alternatively the first solid material and the second solid material may be present in the form of discrete particles which have been blended, optionally in combination with a binder material and one or more further materials, and wherein the blend is preferably compacted. Alternatively the first solid material and the second solid material may be present in the form of different layers of a multilayer thin sheet or film, preferably a multilayer thin sheet or film having a total thickness of less than 500 micron, preferably less than 200 micron. Such solid compositions comprising a first solid material which is the solid material as described herein, and further comprising at least a second solid material having a different composition than the first solid material are particularly useful as cathodes, anodes or separators for an electrochemical cell, in particular as separator or cathode. In some embodiments the second solid material is a cathode material, such as a Nickel-Cobalt or a Nickel-Manganese-Cobalt cathode material.

### Embodiment 4

In another aspect of the invention, there is provided an electrochemical cell comprising the solid material as described herein (i.e. the solid material of embodiment 2). In particular, there is provided an electrochemical cell wherein the cathode, anode and/or separator comprises the solid material as defined herein. In some embodiments there is provided an electrochemical cell wherein the cathode, anode and/or separator comprises the solid material as defined herein in the form of a solid composition comprising a first solid material which is the solid material as described herein, and further comprising at least a second solid material having a different composition than the first solid material. Such solid compositions are described in the context of another aspect of the invention. In particularly preferred embodiments of the invention there is provided an electrochemical cell wherein the separator comprises, the solid material as defined herein, optionally in the form of the solid composition as described herein. In some embodiments, the separator consists of the solid material as described herein.

### Embodiment 5

In another aspect of the invention, there is provided the use of the solid material as described herein (i.e. the solid material of embodiment 2), or of the solid composition as described herein (i.e. the solid composition of embodiment 3), as a solid electrolyte for an electrochemical cell. Preferably, there is provided the use of the solid material as described herein as a solid electrolyte for an electrochemical cell.

In the context of the various aspects of the invention described herein, suitable electrochemically active cathode materials and suitable electrochemically active anode materials are those known in the art. For example, the anode may comprises graphitic carbon, metallic lithium or a metal alloy comprising lithium as the anode active material. For example, the cathode may comprise a Nickel-Cobalt or a Nickel-Manganese-Cobalt cathode material. Electrochemical cells as described herein are preferably lithium-ion containing cells wherein the charge transport is effected by Li⁺ ions. The electrochemical cell may have a disc-like or a prismatic shape. The electrochemical cells can include a housing that can be from steel or aluminum. A plurality of electrochemical cells may be combined to an all solid-state battery, which has both solid electrodes and solid electrolytes.

### Embodiment 6

Another aspect of the present invention concerns batteries, more specifically a lithium ion battery or a lithium metal battery comprising at least one electrochemical cell comprising the solid material as described herein (i.e. the solid material of embodiment 2), for example two or more electrochemical cells as described in embodiment 4. Certain embodiments relate to a solid state battery, preferably a lithium solid state battery comprising at least one electrochemical cell comprising the solid material as described herein (i.e. the solid material of embodiment 2), for example two or more electrochemical cells as described in embodiment 4. Electrochemical cells as described in embodiment 4 can be combined with one another, for example in series connection or in parallel connection. Series connection is preferred. The electrochemical cells resp. batteries described herein can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

### Embodiment 7

A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one battery or at least one electrochemical cell comprising the solid material as described herein (i.e. the electrochemical cell as described in embodiment 4).

### Embodiment 8

A further aspect of the present disclosure is the use of the electrochemical cell comprising the solid material of the invention (i.e. the electrochemical cell as described in embodiment 4) in motor vehicles, bicycles operated by electric motor, robots, aircraft (for example unmanned aerial vehicles including drones), ships or stationary energy stores. The present invention further provides a device comprising at least one electrochemical cell as described in embodiment 5. Preferred are mobile devices such as vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated further by the following examples which are not limiting.

### Examples

### 1. Preparation of Materials

For the comparative examples, 15 g of final material has been produced using the following starting products: amorphous B₂S₃ (99 wt. %), Li₂S (99.9 wt. %), B₂O₃ (99.95 wt. %) and LiX(LiI (99.9 wt. %), LiBr (99 wt. %), LiCl (99.9 wt. %)). In an argon filled glovebox, appropriate amounts of starting materials were weighed, mixed and introduced in a carbon coated silica ampoule. The tube was sealed and introduced in a vertical rocking furnace. The melt was homogenized for 30 minutes at an internal temperature of 950° C. and then quenched in water at room temperature. The ampoule was then opened in the argon filled glovebox. Glassy material was obtained having orange or brown color with good transparency.

For the examples, an alternative synthesis was performed and successful wherein the amount of Boron and Sulfur brought by B₂S₃ was provided in the form of amorphous elemental B (99%) and elemental S (99.999%). It was observed that the glasses obtained starting from elemental Boron and elemental sulfur instead of B₂S₃ were substantially free of edge bubbles, free of visible inclusions while the glasses obtained starting from B₂S₃ had a large amount of visibly discernable edge bubbles as well as carbon inclusions from the ampoule. Inclusions presence is a problem for the post processing of the glass. This type of defect can act as nucleation agent and will favor crystallization of the material. The presence of defect induce a material that is no longer isotropic so it is problematic for protective behavior against dendrite.

### 2. Determination of Thermal Stability ΔTₓ

Thermal analysis was performed with Differential Scanning calorimetry DSC 3500 Sirius. A sample of between 5 and 10 mg of the glassy material was placed in a sealed aluminum pan and analyzed using the following temperature profile: from 100° C. to 350° C. at a rate of 10° C./min. For every sample, the glass transition temperature (T_{g}) and the onset of crystallization (Tₓ) was determined. The thermal stability was then estimated from a simple difference between those values (ΔTₓ=Tₓ−T_{g}).

The glass transition temperature (T_{g}) was determined by constructing tangents to the DSC curve baselines before and after the glass transition and determining the extrapolated onset temperature by intersection of these tangents, essentially corresponding to the temperature where the highest slope in the drop of the DSC baseline occurs before the exothermic crystallization peak. The T_{g} onset temperature determined in this way was used as the T_{g}.

### 3. Determination of Conductivity

Ionic conductivity was measured by electrochemical impedance spectroscopy (EIS) at room temperature (25° C.) on hot pressed samples in a pellet cell with ion blocking electrodes. The samples were densified at 350 MPa at 125° C. for 5 min. The ionic conductivity was measured under an operational pressure of 125 MPa. For the EIS an excitation voltage of 10 mV was applied in the frequency range of 7 MHZ-1 Hz. The data was interpreted by means of an equivalent circuit analysis.

Electronic conductivity was measured at room temperature (25° C.) on hot pressed samples in a pellet cell with ion blocking electrodes. The samples were densified at 350 MPa at 125° C. for 5 min. The electronic conductivity was measured under an operational pressure of 125 MPa. The electronic conductivity was measured via stepwise potentiostatic polarization at 0.2, 0.4 and 0.6 V for 20 min.

Both measurements were conducted with a potentiostat with frequency analyzer (Biologic).

### 4. Determination of Identity of Obtained Glass

Inductively Coupled Plasma Optical Emission Spectroscopy (ICP-OES) was applied to the glassy materials of the examples, prepared as explained above.

A sample of the glassy material is weighed in a glovebox under Ar atmosphere to avoid reaction with water or 02 and added to a microwave vessel. A combination of acids is added, the vessels are closed and digested in a microwave until clear. The matrix elements (Li & B) are analyzed using a high-precision ICP-OES method.

S is determined via elemental analysis after sample preparation in an Ar-filled glovebox. Sample preparation consists of inserting about 100 mg sample in a sealable capsule, followed by adding the sealed capsule and additives to the ceramic crucible. The filled crucible is subsequently heated in induction furnace under a O₂ atmosphere. The S present is released from the sample, converted into SO₂ gas and detected by a SO₂-specific IR detector. The detected SO₂ signal is finally converted into a S concentration by using a calibration line and taking the exact sample mass into consideration.

The composition of the glasses was found to correspond within the expected margin of experimental error and variation to the overall formula expected based on the molar ratios of the precursors which were submitted to melt-quenching.

### 5. Results

TABLE 1
overall formulas of the synthesized compositions

| | Component A | | | Component | Molar ratio | |
|---|---|---|---|---|---|---|
| | Li₂S | B₂S₃ | B₂O₃ | B | A:B | Overall formula |
| Comparative | 60 | 40 | 0 | / | / | Li_{0.32}B_{0.21}S_{0.47} |
| example A | | | | | | |
| Comparative | 70 | 27 | 3 | / | / | Li_{0.39}B_{0.17}S_{0.42}O_{0.03} |
| example B | | | | | | |
| Comparative | 57 | 38 | 5 | / | / | Li_{0.30}B_{0.22}S_{0.44}O_{0.04} |
| example C | | | | | | |
| Example 1 | 70 | 27 | 3 | LiI | 9:1 | Li_{0.40}B_{0.16}S_{0.40}O_{0.02}I_{0.03} |
| Example 2 | 57 | 38 | 5 | LiCl | 9:1 | Li_{0.31}B_{0.21}S_{0.42}O_{0.04}Cl_{0.03} |
| Example 3 | 65 | 33 | 2 | LiBr | 9:1 | Li_{0.36}B_{0.18}S_{0.42}O_{0.02}Br_{0.03} |
| Example 4 | 65 | 31.5 | 3.5 | LiI | 9:1 | Li_{0.36}B_{0.18}S_{0.41}O_{0.03}I_{0.03} |
| Example 5 | 65 | 30 | 5 | LiI | 9:1 | Li_{0.36}B_{0.18}S_{0.40}O_{0.04}I_{0.03} |
| Example 6 | 65 | 30 | 5 | LiI | 85:15 | Li_{0.36}B_{0.17}S_{0.38}O_{0.04}I_{0.04} |
| Example 7 | 65 | 30 | 5 | LiI | 78:22 | Li_{0.37}B_{0.16}S_{0.36}O_{0.04}I_{0.07} |
| Example 8 | 65 | 30 | 5 | LiBr | 9:1 | Li_{0.36}B_{0.18}S_{0.40}O_{0.04}Br_{0.03} |
| Example 9 | 65 | 30 | 5 | LiBr | 85:15 | Li_{0.36}B_{0.17}S_{0.38}O_{0.04}Br_{0.04} |
| Example 10 | 65 | 30 | 5 | LiBr | 8:2 | Li_{0.37}B_{0.17}S_{0.37}O_{0.04}Br_{0.06} |
| Example 11 | 65 | 30 | 5 | LiCl | 9:1 | Li_{0.36}B_{0.18}S_{0.40}O_{0.04}Cl_{0.03} |
| Example 12 | 65 | 30 | 5 | LiCl | 85:15 | Li_{0.36}B_{0.17}S_{0.38}O_{0.04}Cl_{0.04} |

TABLE 2

| | | | | Ionic | Electric |
|---|---|---|---|---|---|
| | Tₓ | T_{g} | ΔTₓ | conductivity | conductivity |
| | (° C.) | (° C.) | (° C.) | (mS/cm) | (mS/cm) |
| Comparative | 294 | 203 | 91 | NA | NA |
| example A | | | | | |
| Comparative | 220 | 153 | 67 | NA | NA |
| example B | | | | | |
| Comparative | 262 | 188 | 74 | NA | NA |
| example C | | | | | |
| Example 1 | 240 | 162 | 78 | 0.26 | 1.13 × 10⁻⁵ |
| Example 2 | 159 | 245 | 86 | 0.27 | 1.16 × 10⁻⁵ |
| Example 3 | 175 | 290 | 115 | 0.62 | 5.52 × 10⁻⁶ |
| Example 4 | 298 | 173 | 125 | 0.55 | 4.84 × 10⁻⁶ |
| Example 5 | 300 | 181 | 119 | 0.56 | 1.4 × 10⁻⁴ |
| Example 6 | 294 | 166 | 128 | 0.49 | 1.92 × 10⁻⁴ |
| Example 7 | 281 | 158 | 123 | 0.84 | 8.53 × 10⁻⁵ |
| Example 8 | 297 | 170 | 127 | 1.26 | 1.27 × 10⁻⁴ |
| Example 9 | 289 | 158 | 131 | 1.12 | 1.17 × 10⁻⁴ |
| Example 10 | 282 | 149 | 133 | 1.02 | 1.51 × 10⁻⁵ |
| Example 11 | 295 | 179 | 116 | 0.82 | 2.85 × 10⁻⁵ |
| Example 12 | 267 | 154 | 113 | 0.331 | 4.68 × 10⁻⁵ |

Tₓ, T_{g}, ionic conductivity and electronic conductivity of each composition;
NA = not available

1-17. (canceled)

18. A method for preparing a solid material comprising the steps of:
(i) providing the following precursors:
Li₂S;
both of boron and sulfur;
B₂O₃; and
optionally LiX wherein X represents F, Cl, Br, I, N₃, SCN, CN, OCN, BF₄, BH₄, or combinations thereof;
(ii) preparing a mixture comprising the precursors provided in step (i);
(iii) heat-treating the mixture prepared in step (ii) to obtain a melt; and
(iv) quenching the melt obtained in step (iii) to obtain the solid material.

19. The method according to claim 18, wherein X represents Cl, Br, I, or combinations thereof.

20. The method according to claim 18, wherein the molar ratio of the precursors in the mixture before quenching is such that in step (ii) a composition according to general formula (I) is obtained
((Li₂S)ₓ(B₂S₃)_{y}(B₂O₃)_{z})_{A}(LiX)_{B} (I)
wherein:
x is within the range of 55 to 85;
y is within the range of 15 to 45;
z is within the range of 0 to 15;
x+y+z=100; and
the ratio A:B is within the range of 60:40 to 100:0.

21. The method according to claim 20, wherein z is within the range of 1 to 15.

22. The method according to claim 20, wherein:
x is within the range of 62 to 68;
y is within the range of 27 to 33;
z is within the range of 1 to 8; and
x+y+Z=100.

23. The method according to claim 22, wherein:
x is about 65;
y is about 30; and
z is about 5.

24. The method according to claim 18, wherein the solid material is a glassy solid.

25. The method according to claim 18, wherein the solid material has an ionic conductivity at 25° C. of at least 0.1 mS/cm.

26. The method according to claim 18, wherein the solid material has a thermal stability ΔTₓ of more than 100° C., wherein ΔTₓ=Tₓ−T_{g}, wherein Tₓ is the crystallization onset temperature as determined by DSC and T_{g} is the glass transition temperature as determined by DSC.

27. The method according to claim 18, wherein step (iii) comprises heat-treating the mixture prepared in step (ii) to a temperature of at least 400° C.

28. The method according to claim 18, wherein step (ii) comprises mechanical milling.

29. The method according to claim 18, wherein step (iii) is performed in a closed vessel.

30. The method according to claim 18, wherein step (iv) further comprises the steps of:
(a) quenching the melt obtained in step (iii) to obtain solid material;
(b) comminuting the solid material of step (iv) a to obtain a particulate solid; and
(c) optionally forming a thin film or sheet by:
dissolving or suspending the particulate solid of step (iv) b in a liquid phase to obtain a solution or suspension, followed by deposition from the solution or suspension to obtain the thin film or sheet; or
reheating the particulate solid of step (iv) b to a temperature sufficient to allow drawing a film or sheet, and drawing said film or sheet.

31. A solid material which is obtainable by the method according to claim 18, and which is substantially free of gas inclusions.

32. An electrochemical cell comprising the solid material of claim 31.

33. The electrochemical cell according to claim 32 comprising a cathode, anode and separator, wherein the separator comprises the solid material of claim 31.

34. A solid electrolyte for an electrochemical cell comprising the solid material of claim 31.
